(19) United States
(12) Patent Application Publication
(10) Pub. No.: US 2026/0109578 A1
(43) Pub. Date: Apr. 23, 2026

(54) A LIFTING ARRANGEMENT AND METHOD FOR INSTALLING A COMPONENT OF A WIND TURBINE

(71) Applicant: Vestas Wind Systems A/S, Aarhus N. (DK)

(72) Inventors: Torben Ladegaard Baun, Skødstrup (DK); Erik Carl Lehnskov Miranda, Aarhus C (DK); Peter Nordlyng, Hobro (DK)

(73) Assignee: Vestas Wind Systems A/S, Aarhus N. (DK)

(21) Appl. No.: 19/113,984

(22) PCT Filed: Sep. 18, 2023
(86) PCT No.: PCT/DK2023/050222

§ 371 Date: Mar. 21, 2025

(30) Foreign Application Priority Data
Sep. 30, 2022 (DK) PA202270474

(51) Int. Cl. B66C 1/10; B66C 13/08; B66C 23/18; F03D 13/10

(52) U.S. Cl. CPC B66C 1/108; B66C 13/08; B66C 23/185; F03D 13/122; F03D 13/139; F05B 2230/61

(57) ABSTRACT

A lifting arrangement for installing and uninstalling a component (16) of a wind turbine (15) is disclosed. The lifting arrangement comprises main yoke (1) being configured to be attached to a main crane (25), and a hoisting mechanism (2, 11) attached to the main yoke (1). The hoisting mechanism (2, 11) is configured to have a component (16) to be installed or uninstalled attached thereto and to move the component (16) relative to the main yoke (1). At least one connecting part (12) is each configured to establish 2024/067929 a pretensioned connection between the main yoke (1) and a nacelle (14) of the wind turbine (15). The pretension of the at least one connecting part (12) is provided by operating a main crane (25) having the main yoke (1) attached thereto. Methods for installing and uninstalling a component (16) in a nacelle (14), using the lifting arrangement, are also disclosed.

### FIELD OF THE INVENTION

The present invention relates to a lifting arrangement for installing or uninstalling a component of a wind turbine, e.g. a gear system, a generator or another suitable wind turbine component. The lifting arrangement according to the invention ensures stability during hoisting of the component. The invention further relates to a method for installing a component of a wind turbine and a method for uninstalling a component of a wind turbine, using such a lifting arrangement.

### BACKGROUND OF THE INVENTION

When installing and uninstalling heavy wind turbine components, such as gear systems, generators, etc., in or near the nacelle of a wind turbine, a large crane is normally used for hoisting the components to or from the installation position. During the part of the movement of the component which takes place near the installation position, there is a risk of collisions or imprecise positioning of the component if there are significant relative movements between the crane and the wind turbine. This is particularly relevant at offshore sites where impact from wind acting on the crane and the component carried by the crane, as well as impact from waves acting on a vessel carrying the crane may cause such significant relative movements. For instance, this may narrow time windows where it is possible to install or uninstall wind turbine components.

Accordingly, it is desirable to introduce measures which stabilise the load being carried by the crane, in the form of the component being installed or uninstalled, relative to the wind turbine. Such measures could, e.g., include applying tag lines or similar.

### DESCRIPTION OF THE INVENTION

It is an object of embodiments of the invention to provide a lifting arrangement for installing and uninstalling a component of a wind turbine, which allows the wind turbine component to be safely installed or uninstalled under a wider variety of weather conditions than prior art lifting arrangements.

It is a further object of embodiments of the invention to provide a method for installing or uninstalling a wind turbine component in a safe manner under a wide variety of weather conditions.

According to a first aspect the invention provides a lifting arrangement for installing and uninstalling a component of a wind turbine, the lifting arrangement comprising:
a main yoke being configured to be attached to main crane,
a hoisting mechanism attached to the main yoke, the hoisting mechanism being configured to have a component to be installed or uninstalled attached thereto and to move the component relative to the main yoke, and
at least one connecting part, each configured to establish a pretensioned connection between the main yoke and a nacelle of the wind turbine, wherein the pretension of the at least one connecting part is provided by operating a main crane having the main yoke attached thereto.

Thus, according to the first aspect, the invention provides a lifting arrangement for installing and uninstalling a component of a wind turbine. In the present context the term ‘lifting arrangement’ should be interpreted to mean an arrangement or a system which is able to handle and carry a wind turbine component being lifted from a position at or near the base of a wind turbine to an uptower installation position, e.g. in or near the nacelle, or vice versa.

The lifting arrangement comprises a main yoke being configured to be attached to a main crane. In the present context the term ‘main crane’ should be interpreted to mean a large crane which is capable of lifting a heavy load from a position near the base of the wind turbine to a position at or near the nacelle of the wind turbine. Accordingly, the main crane is a crane of the type which is normally applied when installing or uninstalling wind turbine components, e.g. as part of erecting or dismantling a wind turbine.

In the present context the term ‘main yoke’ should be interpreted to mean an item which comprises at least one cross bar, and which is configured to carry a load, e.g. a suspended load. Since the main yoke is configured to be attached to the main crane, the main yoke will be carried by the main crane during operation of the lifting arrangement.

The lifting arrangement further comprises a hoisting mechanism being attached to the main yoke. Accordingly, the hoisting mechanism is carried by the main yoke, which is in turn carried by the main crane. In the present context the term ‘hoisting mechanism’ should be interpreted to mean a mechanism or an arrangement which is capable of performing hoisting operations, independently of the lifting performed by the main crane, and relative to the main yoke which carries the hoisting mechanism.

The hoisting mechanism is configured to have a component to be installed or uninstalled attached thereto, and to move the component relative to the main yoke. Accordingly, when a component is attached to the main yoke, and the main yoke is attached to the main crane, the component may be moved relative to the main yoke, by means of the hoisting mechanism, and the main yoke, the hosting mechanism and the component may be moved together by means of the main crane. The movements performed by means of the main crane are typically significantly larger than the movements performed by means of the hoisting mechanism.

The lifting arrangement further comprises at least one connecting part. Each of the connecting part(s) is configured to establish a pretensioned connection between the main yoke and a nacelle of the wind turbine. Accordingly, during operation of the lifting arrangement, one or more pretensioned connections exist between the main yoke and the nacelle of the wind turbine. This ensures that the main yoke is stabilised relative to the nacelle. This, in turn, ensures that the hoisting mechanism carrying the component being installed or uninstalled is stabilised relative to the nacelle, and thereby relative to an installation position for the component. Accordingly, the component can be moved, by means of the hoisting mechanism, in the vicinity of the installation position without risking collisions or inaccurate positioning of the component, even if prevailing weather conditions introduce a risk of significant relative movements between the main crane and the wind turbine. Thereby the time windows during which it is possible to install or uninstall a component of the wind turbine are significantly widened.

The pretension of the at least one connecting part is provided by operating a main crane having the main yoke attached thereto. Accordingly, the at least one pretensioned connection is established by interconnecting the main yoke and the nacelle by means of the at least one connecting part, and subsequently operating the main crane in order to introduce a pretension in each of the at least one connecting part. For instance, the main crane may be pulled upwards, thereby applying a force to the at least one connecting part, which causes the desired pretension. This is an easy and reliable manner of establishing the at least one pretensioned connection between the main yoke and the nacelle, which ensures the desired stability between the hoisting mechanism, and thereby the component, and the nacelle, and thereby the installation position.

The at least one connecting part may be in the form of at least one sling. As an alternative, the at least one connecting part may be in the form of at least one rope, wire, strap, belt, or any other suitable kind of connecting part.

The hoisting mechanism may comprise at least one winch. A winch is very suitable for performing hoisting over smaller distances. As an alternative, the hoisting mechanism may be any other suitable kind of hosting mechanism, such as a small crane, a jacking system, such as a jacking cylinder, etc.

The hoisting mechanism may comprise a lifting yoke configured to be attached to the component to be installed or uninstalled. According to this embodiment, the component being installed or uninstalled is attached to the hoisting mechanism via the lifting yoke. Thereby it is ensured that the component is attached to the hoisting mechanism in a secure and stable manner. Furthermore, it is hereby ensured that load may be distributed among lifting points in a suitable and appropriate manner.

The hoisting mechanism may be configured to operate independently of the at least one connecting part. According to this embodiment, the at least one pretensioned connection, which ensures the stability between the main yoke and the nacelle, is established completely separately from the operation of the hoisting mechanism, and thereby from the final movement of the component being installed or uninstalled. Thus, once the main yoke is in position near the nacelle, it is kept stabilised by means of the main crane providing the pretension of the connecting part(s), and the component is move to or from the installation position by means of the hoisting mechanism. Accordingly, the pretension is provided in a manner which does not affect the final movements of the component, and the final movements of the component are performed in a manner which does not affect the introduced pretension. Thereby a constant and stable pretension is ensured.

The component to be installed or uninstalled may be a gear system or a generator. The gear system and the generator of a wind turbine are examples of wind turbine components which are relatively heavy, and which need to be installed, and sometimes uninstalled, at installation positions in or near the nacelle of the wind turbine. Accordingly, the lifting arrangement according to the first aspect of the invention is suitable for installing or uninstalling the gear system and/or the generator of a wind turbine.

As an alternative, the component to be installed or uninstalled may be any other suitable kind of wind turbine component, such as a transformer, a wind turbine blade, a rotor, etc.

The wind turbine may be an offshore wind turbine. In this case the main crane may be positioned on a seagoing vessel, such as a barge, moored adjacent to the wind turbine. In this case there is an increased risk of significant relative movements between the main crane and the wind turbine, and therefore it is particularly relevant to apply the lifting arrangement according to the first aspect of the invention.

As an alternative, the wind turbine may be an onshore wind turbine.

According to a second aspect the invention provides a method for installing a component in a nacelle of a wind turbine, the method comprising the steps of:
providing a lifting arrangement according to the first aspect of the invention,
attaching the component to be installed to the hoisting mechanism of the lifting arrangement,
attaching the main yoke of the lifting arrangement to a main crane,
lifting the main yoke, carrying the hoisting mechanism and the component to be installed, towards the nacelle of the wind turbine by means of the main crane,
attaching the at least one connecting part of the lifting arrangement to the nacelle of the wind turbine,
operating the main crane in order to provide pretension in the at least one connecting part, thereby establishing at least one pretensioned connection between the main yoke and the nacelle of the wind turbine,
installing the component in the nacelle of the wind turbine, using the hoisting mechanism, and detaching the component from the hoisting mechanism, and
detaching the at least one connecting part from the nacelle.

The method according to the second aspect of the invention is a method for installing a component in a nacelle of a wind turbine, i.e. the component is positioned in the nacelle. This could, e.g., take place as a part of erecting the wind turbine, or the component may be installed after completion of external maintenance or repair, or it may replace a previous component.

Thus, in the method according to the second aspect of the invention, a lifting arrangement according to the first aspect of the invention is initially provided. Accordingly, the remarks set forth above with reference to the first aspect of the invention are equally applicable here.

Next, the component to be installed is attached to the hoisting mechanism of the lifting arrangement. This could, e.g., including attaching the component to a lifting yoke.

Furthermore, the main yoke of the lifting arrangement is attached to a main crane. It should be noted that the component may be attached to the hoisting mechanism before the main yoke is attached to the main crane, or vice versa. In any event, the component is eventually connected to the main crane via the hoisting arrangement and the main yoke.

Next, the main crane is operated in such a manner that the main yoke is lifted towards the nacelle of the wind turbine. Since the main yoke carries the hoisting mechanism, which in turn carries the component to be installed, the main yoke, the hoisting mechanism and the component are lifted in unison towards the nacelle of the wind turbine, by means of the main crane. Accordingly, the component is moved from a position at the base of the wind turbine to a position near the nacelle by means of the main crane.

Once the main yoke has reached a position near the nacelle, the at least one connecting part of the lifting arrangement is attached to the nacelle of the wind turbine. The at least one connecting part is further attached to the main yoke, if this is not already the case. Thereby at least one connection is established between the main yoke and the nacelle.

Next, the main crane is operated in order to provide pretension in the at least one connecting part. Thereby at least one pretensioned connection is established between the main yoke and the nacelle of the wind turbine. This could, e.g., be performed by pulling the main yoke upwards, by means of the main crane, until a desired pretension has been introduced in the at least one connecting part.

When a desired pretension has been introduced in the manner described above, the pretension ensures that the main yoke remains stable relative to the nacelle. The component is then installed in the nacelle of the wind turbine, using the hoisting mechanism, and the component is detached from the hoisting mechanism.

When the component is well in position and detached from the hoisting mechanism, the at least on connecting part is detached from the nacelle. This may include operating the main crane in order to remove the pretension, and subsequently detaching the at least one connecting part from the nacelle.

The method may further comprise the step of lowering the main yoke from the nacelle by means of the main crane, after detaching the at least one connecting part from the nacelle.

According to this embodiment, the main yoke is returned to a position at the base of the wind turbine once the component has been successfully installed in the wind turbine.

The step of installing the component in the nacelle may comprise the steps of:
operating the hoisting mechanism in order to position the component relative to the nacelle,
mounting the component in the nacelle, and
detaching the component from the hoisting mechanism.

According to this embodiment, once the main yoke, carrying the hosting mechanism and the component to be installed, has been lifted to a position near the nacelle of the wind turbine, and the at least one pretensioned connection between the main yoke and the nacelle has been established, the hoisting mechanism is operated in such a manner that the component is moved towards an installation position. This could, e.g., include lowering the component towards an installation position inside the nacelle.

When the component has reached the installation position, and thereby its final destination, it is mounted in the nacelle, at the installation position. This could, e.g., include securing the component to relevant support structures, connecting the component to other relevant components of the wind turbine, e.g. mechanically, fluidly and/or hydraulically, etc. For instance, in the case that the component is a gear system it should be mechanically connected to the rotor and to the generator, and it should be fluidly connected to a lubrication system and possibly a cooling system. In any event, the mounting of the component should bring the component into a position and state where it is fully operational within the wind turbine.

When the component has been securely mounted in the nacelle, it is detached from the hoisting mechanism. This allows the hoisting mechanism, and also the remaining parts of the lifting arrangement, to be removed from the position near the nacelle.

The step of lifting the main yoke towards the nacelle may comprise positioning the main yoke above the nacelle of the wind turbine.

According to this embodiment, the at least one connecting part extends from the nacelle upwards towards the main yoke. Thereby the pretension can be introduced in the at least one connecting part by pulling the main yoke upwards by means of the main crane. Furthermore, the hoisting mechanism, carrying the component to be installed, will be suspended below the main yoke and above the nacelle, thereby allowing the hoisting mechanism to lower the component into position in the nacelle in a controlled manner.

According to a third aspect the invention provides a method for uninstalling a component in a nacelle of a wind turbine, the method comprising the steps of:
providing a lifting arrangement according to the first aspect of the invention,
attaching the main yoke of the lifting arrangement to a main crane,
lifting the main yoke, carrying the hoisting mechanism of the lifting arrangement, towards the nacelle of the wind turbine by means of the main crane,
attaching the at least one connecting part of the lifting arrangement to the nacelle of the wind turbine,
operating the main crane in order to provide pretension in the at least one connecting part, thereby establishing at least one pretensioned connection between the main yoke and the nacelle of the wind turbine,
uninstalling the component from the nacelle of the wind turbine, using the hoisting mechanism,
detaching the at least one connecting part from the nacelle, and
lowering the main yoke, carrying the hoisting mechanism and the component, from the nacelle by means of the main crane.

The method according to the third aspect of the invention is a method for uninstalling a component in a nacelle of a wind turbine, i.e. the component is removed from the nacelle. This could, e.g., take place as a part of dismantling of the wind turbine, or the component may need to be uninstalled due to maintenance, repair or replacement.

The method according to the third aspect of the invention is essentially a reversal of the method according to the second aspect of the invention.

Accordingly, the remarks set forth above with reference to the second aspect of the invention are equally applicable here.

In the method according to the third aspect of the invention, a lifting arrangement according to the first aspect of the invention is initially provided. Accordingly, the remarks set forth above with reference to the first aspect of the invention are equally applicable here.

Next, the main yoke of the lifting arrangement is attached to a main crane, and the main yoke, carrying the hoisting mechanism of the lifting arrangement, is lifted towards the nacelle of the wind turbine by means of the main crane. Accordingly, the main yoke and the hoisting arrangement are moved from a position near the base of the wind turbine to a position near the nacelle of the wind turbine, and thereby to a position which is near to the position of the component to be uninstalled.

The at least one connecting part of the lifting arrangement is then attached to the nacelle. Furthermore, the at least one connecting part is connected to the main yoke, if this is not already the case. Accordingly, at least one connection between the main yoke and the nacelle has now been established by means of the at least one connecting part.

Next, the main crane is operated in order to provide pretension in the at least one connecting part, thereby establishing at least one pretensioned connection between the main yoke and the nacelle of the wind turbine. This is similar to what is described above with reference to the second aspect of the invention. Accordingly, the at least one pretensioned connection ensures that the main yoke is stabilised relative to the nacelle, thereby reducing relative movements there between and allowing the hoisting mechanism to operate in an accurate manner.

The component is then uninstalled from the nacelle of the wind turbine, using the hoisting mechanism. Accordingly, the movement of the component in the vicinity of the installation position in the nacelle are handled by the hoisting mechanism while the main yoke carrying the hoisting mechanism is stabilised relative to the nacelle, due to the at least one pretensioned connection. This is similar to the situation described above with reference to the second aspect of the invention.

Once the component has been uninstalled, the at least one connecting part is detached from the nacelle, and the main yoke, carrying the hoisting mechanism and the component, is lowered from the nacelle by means of the main crane. Accordingly, the component is thereby moved from a position near the nacelle to a position near the base of the wind turbine, by means of the main crane, and while being carried by the hoisting mechanism.

The method according to the second aspect of the invention and the method according to the third aspect of the invention may be combined, e.g. in the case that a component of the wind turbine needs to be replaced. In this case the old component is initially uninstalled from the nacelle by performing the method according to the third aspect of the invention, and the new component is subsequently installed in the nacelle by performing the method according to the second aspect of the invention.

The step of uninstalling the component from the nacelle of the wind turbine may comprise the steps of:
dismantling the component,
attaching the component to the hoisting mechanism, and
operating the hoisting mechanism in order to remove the component from an installed position in the nacelle.

According to this embodiment, once the main yoke and the hoisting mechanism are in position near the nacelle, and the at least one pretensioned connection has been established, the component is dismantled. This may include releasing the component from any support structure it may be attached to, as well as mechanically, fluidly and/or hydraulically disconnecting the component from any other relevant component of the wind turbine. Accordingly, the component is now free to be moved relative to the nacelle.

The thus dismantled component is then attached to the hoisting mechanism, and the hoisting mechanism is operated in such a manner that the component is removed from its installed position in the nacelle.

The step of lifting the main yoke towards the nacelle may comprise positioning the main yoke above the nacelle of the wind turbine. This is similar to the situation described above with reference to the second aspect of the invention.

### BRIEF DESCRIPTION OF THE DRAWINGS

The invention will now be described in further detail with reference to the accompanying drawings in which

FIGS. 1-3 illustrate a main yoke for a lifting arrangement according to an embodiment of the invention,

FIGS. 4 and 5 show the main yoke of FIGS. 1-3 positioned on a support frame, and

FIGS. 6-16 illustrate a method for uninstalling a component in a nacelle of a wind turbine according to an embodiment of the invention.

### DETAILED DESCRIPTION OF THE DRAWINGS

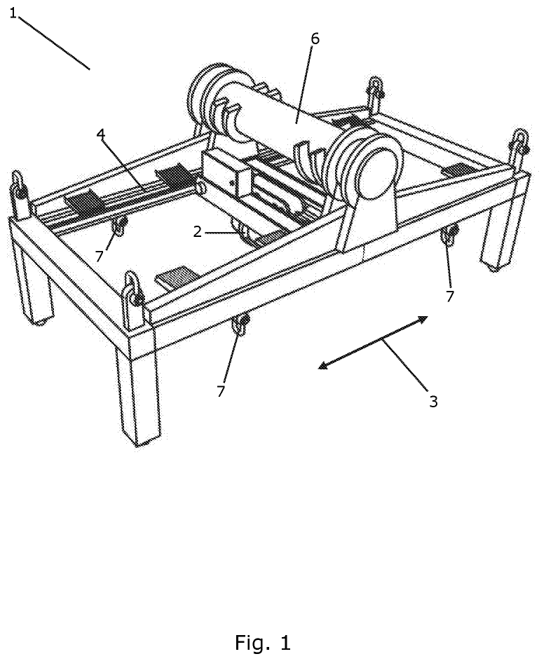

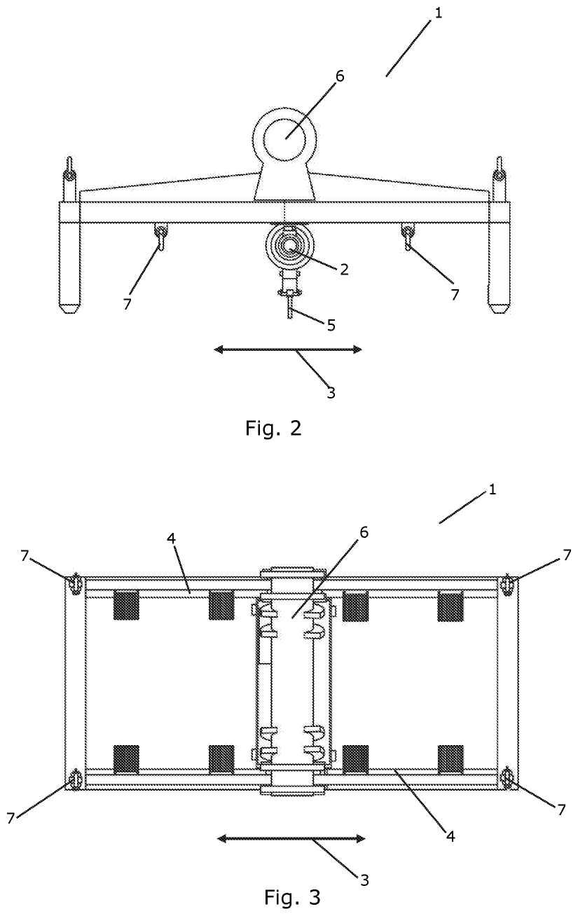

FIGS. 1-3 illustrate a main yoke 1 for a lifting arrangement according to an embodiment of the invention. FIG. 1 is a perspective view of the main yoke 1, FIG. 2 is a side view of the main yoke 1, and FIG. 3 is a view from below of the main yoke 1.

A hoisting mechanism in the form of a winch 2 is attached to the main yoke 1. The winch 2 can move relative to the main yoke 1 in a direction illustrated by double arrow 3, via guide rails 4 formed on the main yoke 1. A hook 5 is connected to the winch 2, thereby allowing a load to be attached to the winch 2, and thereby to the main yoke 1. When a load is attached to the hook 5, it can be hoisted or lowered relative to the main yoke 1 by appropriately operating the winch 2.

The main yoke 1 is further provided with a transversal beam 6 which is configured to be connected to a hook of a main crane, thereby allowing the main yoke 1, along with the winch 2, to be lifted by means of the main crane.

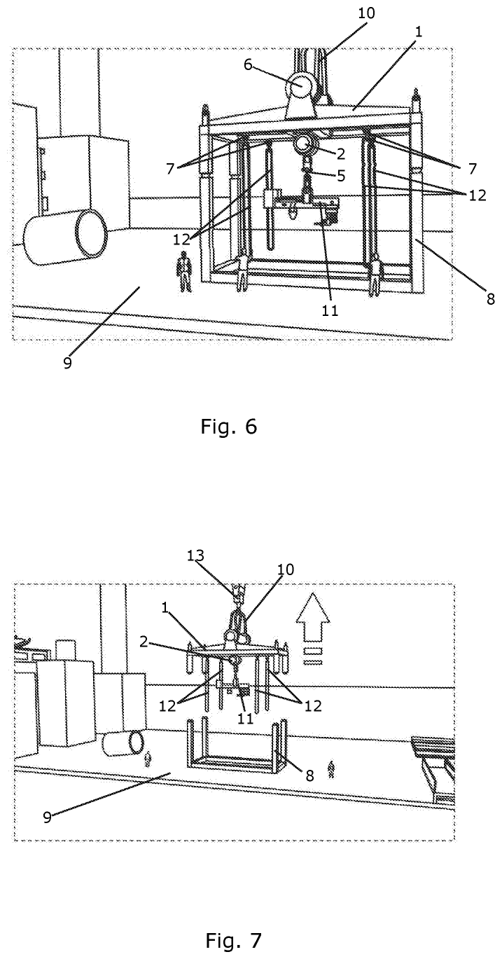

Four eyelets 7 are arranged on a lower part of the main yoke 1. Connecting parts, e.g. in the form of slings, can be attached to the eyelets 7 in order to establish pretensioned connections between the main yoke 1 and a nacelle of a wind turbine. This will be described in further detail below with reference to FIGS. 6-16.

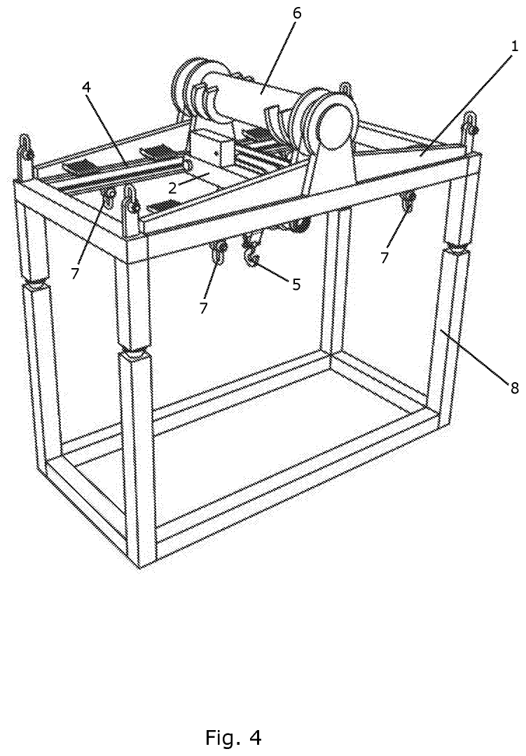

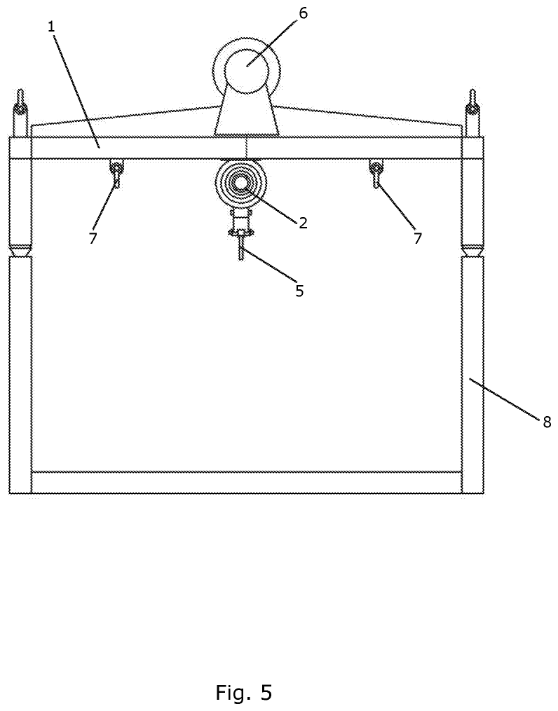

FIGS. 4 and 5 shows the main yoke 1 of FIGS. 1-3 positioned on a support frame 8. FIG. 4 is a perspective view of the main yoke 1 and the support frame 8, and FIG. 5 is a side view of the main yoke 1 and the support frame 8.

When the main yoke 1 is positioned on the support frame 8, as illustrated in FIGS. 4 and 5, a load can be suspended from the hook 5 of the winch 2 in such a manner that it extends below the lowest part of the main yoke 1, but without colliding with ground. Thus, the support frame 8 provides a distance or space between the main yoke 1 and the ground, and load to be lifted can be accommodated within this space. This is obtained without requiring that the dimensions of the main yoke 1, e.g. a length of the ‘legs’ of the main yoke 1, are increased to provide such a distance or space.

FIGS. 6-16 illustrate a method for uninstalling a component of a wind turbine according to an embodiment of the invention. The method illustrated in FIGS. 6-16 applies the main yoke 1 of FIGS. 1-5.

In FIG. 6, the main yoke 1 is positioned on a support frame 8, which is positioned on a seagoing vessel 9. The transversal beam 6 is connected to a main crane (not shown) via straps 10. A lifting yoke 11 is attached to the hook 5 of the winch 2. Four connecting parts 12, in the form of slings, are mounted in the eyelets 7.

In FIG. 7, the main yoke 1 has been lifted slightly off the support frame 8, by operating the main crane (not shown). The main yoke 1 is thereby being lifted towards a nacelle of an offshore wind turbine (not shown). The seagoing vessel 9 is positioned adjacent to the offshore wind turbine, e.g. moored adjacent to the offshore wind turbine. It can be seen that the straps 10 are attached to a hook 13 of the main crane.

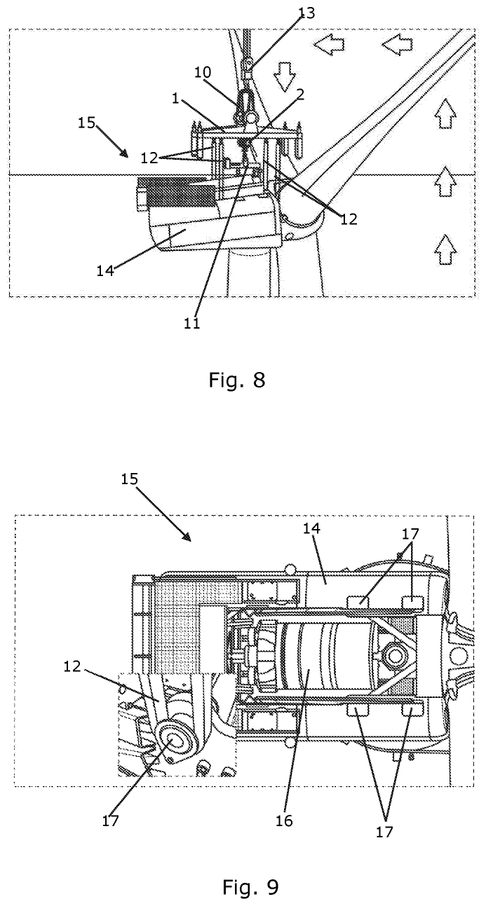

In FIG. 8, the main yoke 1 has been lifted to a position above a nacelle 14 of a wind turbine 15. It can be seen that the slings 12 are positioned close to the nacelle 14.

FIG. 9 shows the nacelle 14 from above. A roof of the nacelle 14 is open, thereby revealing the interior of the nacelle 14. A gear system 16 which is to be uninstalled from the nacelle 14 can be seen.

The nacelle 14 is provided with four attachment portions 17 where the four slings 12 of the main yoke 1 can be attached, thereby establishing four connections between the main yoke 1 and the nacelle 14. The insert shows how one of the slings 12 is attached to one of the attachment portions 17.

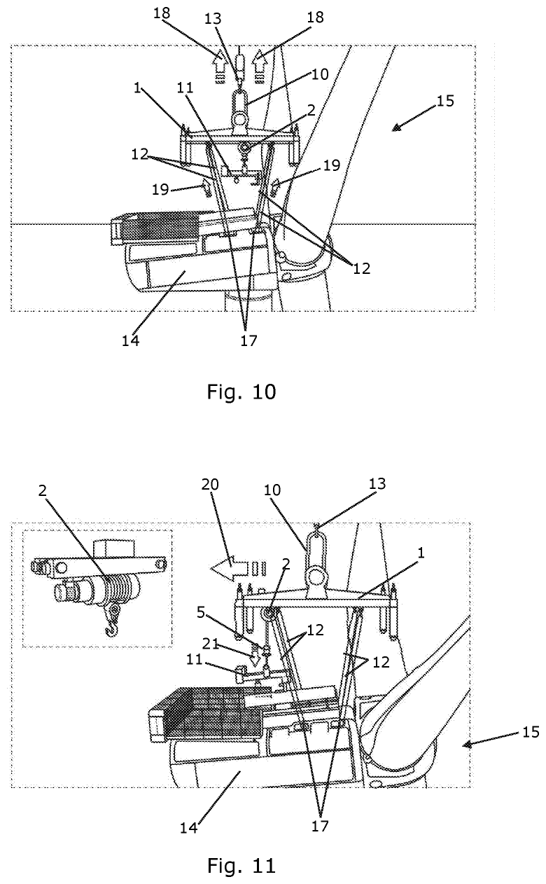

In FIG. 10 the four slings 12 have each been attached to one of the four attachment positions 17. The main crane is then operated in such a manner that the main yoke 1 is pulled in an upwards direction, as indicated by arrows 18. This causes a pull in the slings 12 which are interconnecting the main yoke 1 and the nacelle 14, as indicated by arrows 19. This pull introduces a pretension in the slings 12, and thereby four pretensioned connections are established between the main yoke 1 and the nacelle 14.

The pretensioned connections ensure that the main yoke 1 is stabilised relative to the nacelle 14, and thereby relative to the gear system (not visible in FIG. 10) which is to be uninstalled.

In FIG. 11, the winch 2 has been moved along the guide rails (not visible in FIG. 11) of the main yoke 1, as indicated by arrow 20, in order to position the lifting yoke 11 immediately above the gear system (not visible in FIG. 11). Furthermore, the winch 2 is being operated in order to lower the lifting yoke 11 towards the gear system, as indicated by arrow 21. This is done while the main yoke 1 is kept stable relative to the nacelle 14, due to the pretensioned connections established by means of the slings 12 and the pretension introduced by the main crane. Thereby unwanted relative movements between the lifting yoke 11 and the nacelle 14 are minimised, thereby making it easier to accurately steer the lifting yoke 11 towards the gear system.

The insert shows a detailed view of the winch 2.

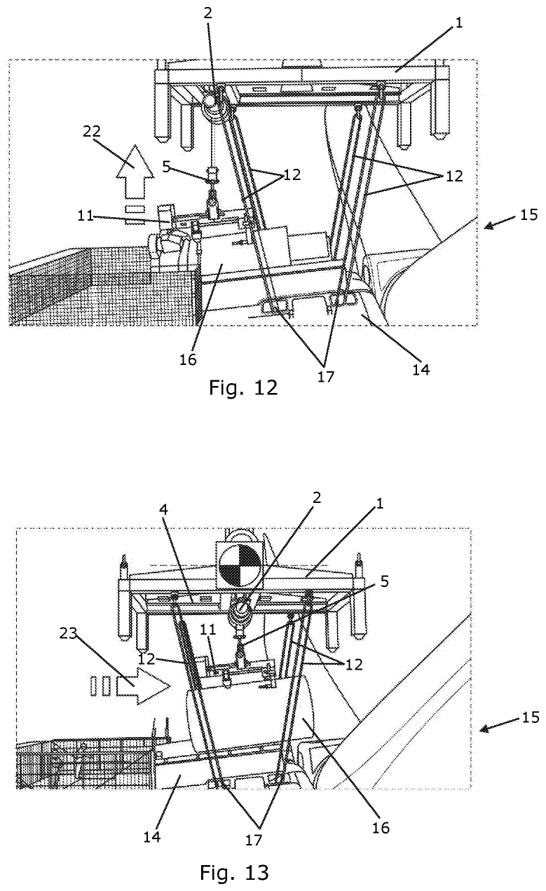

In FIG. 12, the gear system 16 has been dismantled from its installed position inside the nacelle 14, and it has been connected to the lifting yoke 11. The winch 2 is being operated in order to hoist the lifting yoke 11, carrying the gear system 16, as indicated by arrow 22. Thereby the gear system 16 is moved away from its installed position inside the nacelle 14, by means of the winch 2, and while the main yoke 1 is stabilised relative to the nacelle 14, due to the pretensioned connections established by means of the slings 12. Accordingly, unwanted relative movements between the gear system 16 and the nacelle 14 are avoided, and the gear system 16 is removed from the nacelle 14 in a safe and reliable manner.

In FIG. 13, the hoisting of the gear system 16 by means of the winch 2 has been completed, and the winch 2 has been moved to a centre position of the main yoke 1 along the guide rails 4 of the main yoke 1, as illustrated by arrow 23.

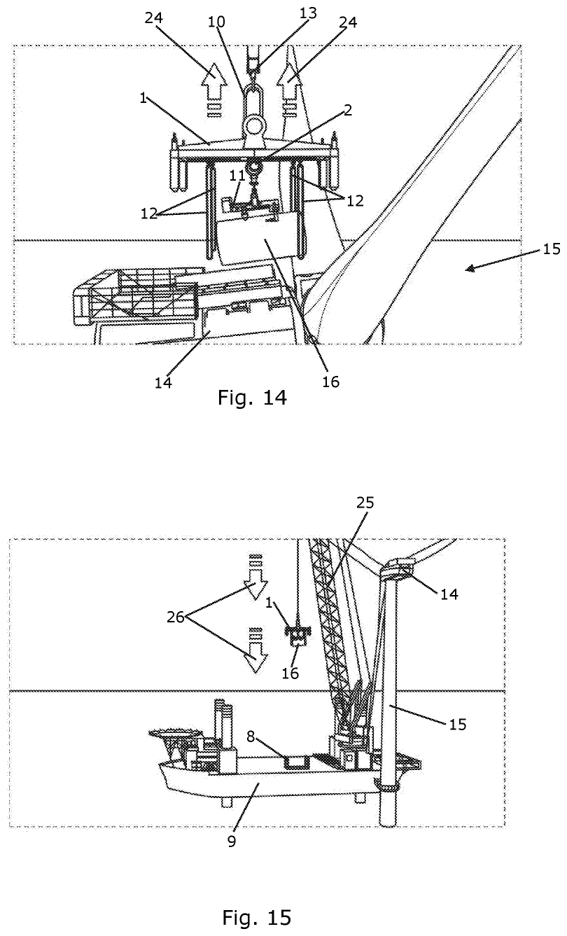

In FIG. 14, the pretension in the slings 12 has been removed, and the slings 12 have been detached from the respective attachment positions 17 at the nacelle 14. Accordingly, there is no longer any connection between the main yoke 1 and the nacelle 14, and the main yoke 1 is therefore free to move relative to the nacelle 14. Accordingly, the main crane is being operated in order to lift the main yoke 1, carrying the lifting yoke 11 and the gear system 16, as illustrated by arrows 24.

In FIG. 15, the main yoke 1, carrying the gear system 16, is in the process of being lowered towards the seagoing vessel 9 by means of the main crane 25, as indicated by arrows 26.

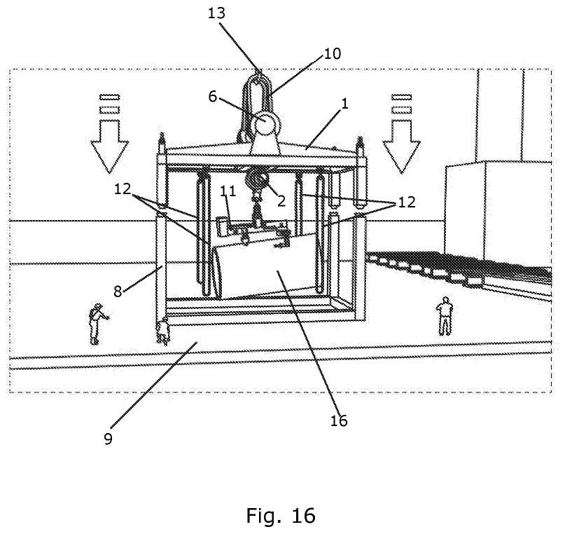

In FIG. 16, the main yoke 1, carrying the gear system 16, is being positioned on the support frame 8 at the seagoing vessel 9. It can be seen that the gear system 16 can be accommodated in the space defined by the main yoke 1 and the support frame 8, as described above with reference to FIGS. 4 and 5.

It should be noted that a method similar to the one illustrated in FIGS. 6-16 could be applied for installing a component, e.g. a gear system 16, in the nacelle 14 of the wind turbine 15. In this case, the component is attached to the lifting yoke 11 while the main yoke 1 is positioned on the support frame 8 in the manner illustrated in FIG. 6. When the main yoke 1 is lifted to the position above the nacelle 14, as illustrated in FIGS. 7 and 8, the component is thereby carried along. The component is then installed in the nacelle 14, rather than uninstalling the component, as illustrated in FIGS. 11-13, while the pretensioned connections established by means of the pretensioned slings 12 ensure stabilisation of the main yoke 1 relative to the nacelle 14. Once the component has been installed in the nacelle 14, the slings 12 are disconnected from the attachment positions 17, and the main yoke 1, without the component, is returned to the seagoing vessel 9, in the manner illustrated in FIGS. 14-16.

1. A lifting arrangement for installing and uninstalling a component of a wind turbine, the lifting arrangement comprising:
a main yoke being configured to be attached to a main crane,
a hoisting mechanism attached to the main yoke, the hoisting mechanism being configured to have a component to be installed or uninstalled attached thereto and to move the component relative to the main yoke, and
at least one connecting part, each configured to establish a pretensioned connection between the main yoke and a nacelle of the wind turbine,
wherein the pretension of the at least one connecting part is provided by operating a main crane having the main yoke attached thereto.

2. The lifting arrangement according to claim 1, wherein the at least one connecting part is in the form of at least one sling (12).

3. The lifting arrangement according to claim 1, wherein the hoisting mechanism comprises at least one winch.

4. The lifting arrangement according to claim 1, wherein the hoisting mechanism comprises a lifting yoke configured to be attached to the component to be installed or uninstalled.

5. The lifting arrangement according to claim 1, wherein the hoisting mechanism is configured to operate independently of the at least one connecting part.

6. The lifting arrangement according to claim 1, wherein the component to be installed or uninstalled is a gear system or a generator.

7. A method for installing a component in a nacelle of a wind turbine, the method comprising the steps of:
providing a lifting arrangement according to claim 1,
attaching the component to be installed to the hoisting mechanism of the lifting arrangement,
attaching the main yoke of the lifting arrangement to a main crane,
lifting the main yoke, carrying the hoisting mechanism and the component to be installed, towards the nacelle of the wind turbine by means of the main crane,
attaching the at least one connecting part of the lifting arrangement to the nacelle of the wind turbine,
operating the main crane in order to provide pretension in the at least one connecting part, thereby establishing at least one pretensioned connection between the main yoke and the nacelle of the wind turbine,
installing the component in the nacelle of the wind turbine, using the hoisting mechanism, and detaching the component from the hoisting mechanism, and
detaching the at least one connecting part from the nacelle.

8. The method according to claim 7, further comprising the step of lowering the main yoke from the nacelle by means of the main crane, after detaching the at least one connecting part from the nacelle.

9. The method according to claim 7, wherein the step of installing the component in the nacelle comprises the steps of:
operating the hoisting mechanism in order to position the component relative to the nacelle,
mounting the component in the nacelle, and
detaching the component from the hoisting mechanism.

10. The method according to claim 7, wherein the step of lifting the main yoke towards the nacelle comprises positioning the main yoke above the nacelle of the wind turbine.

11. A method for uninstalling a component in a nacelle of a wind turbine, the method comprising the steps of:
providing a lifting arrangement according to claim 1
attaching the main yoke of the lifting arrangement to a main crane,
lifting the main yoke, carrying the hoisting mechanism of the lifting arrangement, towards the nacelle of the wind turbine by means of the main crane,
attaching the at least one connecting part of the lifting arrangement to the nacelle of the wind turbine,
operating the main crane in order to provide pretension in the at least one connecting part, thereby establishing at least one pretensioned connection between the main yoke and the nacelle of the wind turbine,
uninstalling the component from the nacelle of the wind turbine, using the hoisting mechanism,
detaching the at least one connecting part from the nacelle, and
lowering the main yoke, carrying the hoisting mechanism and the component, from the nacelle by means of the main crane.

12. The method according to claim 11, wherein the step of uninstalling the component from the nacelle of the wind turbine comprises the steps of:
dismantling the component,
attaching the component to the hoisting mechanism, and
operating the hoisting mechanism in order to remove the component from an installed position in the nacelle.

13. The method according to claim 11, wherein the step of lifting the main yoke towards the nacelle comprises positioning the main yoke above the nacelle of the wind turbine.
